(19) United States
(12) Patent Application Publication
(10) Pub. No.: US 2020/0212576 A1
(43) Pub. Date: Jul. 2, 2020

(54) ANTENNA SHIELD FOR CO-LOCATED ANTENNAS IN A WELLBORE

(71) Applicant: Halliburton Energy Services, Inc., Houston, TX (US)

(72) Inventors: Jin MA, Houston, TX (US); Alexei KOROVIN, Houston, TX (US)

(21) Appl. No.: 16/355,302

(22) Filed: Mar. 15, 2019

Related U.S. Application Data
(63) Continuation of application No. PCT/US2018/068177, filed on Dec. 31, 2018.

(51) Int. Cl. H01Q 7/04; E21B 47/01; E21B 47/12; G01V 3/30; G01V 3/34

(52) U.S. Cl. CPC H01Q 7/04; E21B 47/011; G01V 3/34; G01V 3/30; E21B 47/122

(57) ABSTRACT

A triad antenna shield includes a housing positionable radially external to three loop antennas of a resistivity logging tool in a wellbore. The housing defines three slot sets each corresponding to a respective one of the loop antennas to overlap at least a portion of the respective loop antenna. At least one slot of each slot set is perpendicular to a trace angle with respect to a longitudinal axis. Further, each slot set extends around a circumference of the triad antenna shield and through a first layer of the housing.

### TECHNICAL FIELD

This application claims priority to International Patent Application No. PCT/US2018/068177 entitled “ANTENNA SHIELD FOR CO-LOCATED ANTENNAS IN A WELLBORE”, and filed Dec. 31, 2018, the entirety of which is incorporated herein by reference.

The present disclosure relates to devices for logging or communicating in a wellbore for extracting hydrocarbon fluid. More specifically, though not exclusively, the present disclosure relates to antenna shields for co-located antennas used in wellbore logging tools.

### BACKGROUND

During drilling operations for the extraction of hydrocarbons, a variety of recording and transmission techniques are used to provide or record real-time data from the vicinity of a drill bit. Measurements of surrounding subterranean formations may be made throughout drilling operations using downhole measurement and logging tools, such as measurement-while-drilling (MWD) tools, which aid in making operational decisions, and logging-while-drilling (LWD) tools, which help characterize the formations. LWD tools, in particular, obtain measurements of the subterranean formations being penetrated for determining the electrical resistivity (or its inverse, conductivity) of the subterranean formations. The electrical resistivity indicates various geological features of the formations surrounding a wellbore. These resistivity measurements may be obtained using one or more antennas coupled to or otherwise associated with the wellbore logging tools.

The wellbore logging tool may include loop antennas, each formed from multiple turns of a conductive wire (or coil) wound on an axial section of the wellbore logging tool, such as a drill collar. The wellbore logging tools may be subject to severe mechanical impacts with the borehole wall and with cuttings in the borehole fluid. These impacts may damage the loop antennas (and other components of the tool) if unprotected. Further, protecting the loop antennas with a protective covering may impede sufficient operation of the loop antennas.

### BRIEF DESCRIPTION OF THE DRAWINGS

FIG. 1 is a cross-sectional view of an example of a wellbore drilling environment according to some aspects of the present disclosure.

FIG. 2 is a cross-sectional view of an example wireline environment according to some aspects of the present disclosure.

FIG. 3 is a side view of a resistivity logging tool including three co-located loop antennas according to some aspects of the present disclosure.

FIG. 4 is a side view of an antenna shield for the resistivity logging tool of FIG. 3 according to some aspects of the present disclosure.

FIG. 5 is a side view of the resistivity logging tool of FIG. 3 with the antenna shield of FIG. 4 according to some aspects of the present disclosure.

FIG. 6 is a flowchart of a process for operating the resistivity logging tool of FIGS. 1-5 according to some aspects of the present disclosure.

### DETAILED DESCRIPTION

Certain aspects and examples of the disclosure relate to antenna shields for resistivity logging tools used in the oil and gas industry. More particularly, the present disclosure relates to triad antenna shields including slots that are orientated or otherwise positioned to minimize loss of electromagnetic fields of co-located loop antennas protected by the triad antenna shield.

A resistivity logging tool may include three loop antennas at least partially overlapping each other. Each of the loop antennas of the resistivity logging tool may be formed by winding multiple turns of a coil about a tool mandrel. This overlapping arrangement of the loop antennas may be referred to as a set of co-located antennas. Each loop antenna can include any number of consecutive “turns” (i.e., windings of coil) about the resistivity logging tool, but the loop antennas may typically include at least two or more consecutive full turns. Each full turn extends 360 degrees about the resistivity logging tool. Each loop antenna may be “tilted” or otherwise oriented at an angle relative to the longitudinal axis of the tool, and an orientation of the three loop antennas around the tool mandrel may each be offset from one another by 120 degrees around a circumference of the tool mandrel. To minimize cross-talk between the co-located antennas, each loop antenna may also be tilted at a winding angle of approximately 54.7 degrees relative to the tool axis. In an example, 54.7 degrees is a magnetic dipole angle that makes the loop antennas orthogonal to each other in three-dimensional coordinates. However, the winding angle is not limited in this regard, and the antennas may be disposed at a winding angle greater than 0° and less than 90° relative to the tool axis, without departing from the scope of the disclosure. For example, the winding angle may be between 45 degrees and 65 degrees depending on how severely a metal collar or magnetic layer underneath or surrounding the coil winding may impact the effective magnetic dipole angle.

A triad antenna shield may be a cylindrical structure that axially spans a portion of the resistivity logging tool that includes the co-located antennas and covers the co-located antennas to protect the co-located antennas from mechanical impacts. To permit the electromagnetic (EM) fields to penetrate the antenna shield, and thereby facilitate electromagnetic transmissivity of the antenna shield, a set of slots (or openings) may be defined in the body of the antenna shield. The set of slots may maximize a transmission of EM fields from the loop antennas traced by each set of slots and minimize or reduce leakage of EM fields from other orthogonal loop antennas. Further, an arrangement of the set of slots, as discussed herein, may improve an effective EM field angle and thereby a sensitivity of the resistivity logging tool in relation to a shield that includes crossing slots. In this manner, sensitivity of the loop antennas to the formation may be maximized while cross talk between the orthogonal loop antennas may be minimized.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

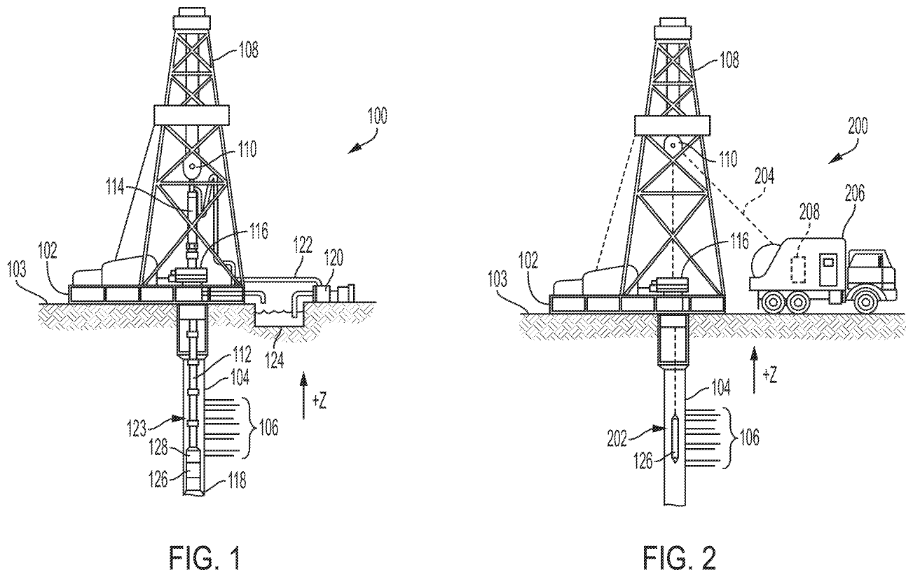

FIG. 1 depicts a cross-sectional view of an example of a wellbore drilling system 100 that may employ the principles of the present disclosure. As illustrated, the drilling system 100 may include a drilling platform 102 positioned at the surface 103 and a wellbore 104 that extends from the drilling platform 102 into one or more subterranean formations 106. The drilling system 100 may include a derrick 108 supported by the drilling platform 102 and having a traveling block 110 for raising and lowering a drill string 112. A kelly 114 may support the drill string 112 as it is lowered through a rotary table 116. A drill bit 118 may be coupled to the drill string 112 and driven by a downhole motor and/or by rotation of the drill string 112 by the rotary table 116. As the drill bit 118 rotates, the drill bit 118 creates the wellbore 104, which penetrates the subterranean formations 106. A pump 120 may circulate drilling fluid through a feed pipe 122 and the kelly 114, downhole through the interior of drill string 112, through orifices in the drill bit 118, back to the surface via an annulus 123 defined around drill string 112, and into a retention pit 124. The drilling fluid may cool the drill bit 118 during operation, and the drilling fluid transports cuttings from the wellbore 104 into the retention pit 124.

The drilling system 100 may also include a bottom hole assembly (BHA) coupled to the drill string 112 near the drill bit 118. The BHA may include various downhole measurement tools such as, but not limited to, measurement-while-drilling (MWD) and logging-while-drilling (LWD) tools, which may take downhole measurements of drilling conditions. The MWD and LWD tools may include at least one resistivity logging tool 126, which may include a triad antenna shield for three co-located antennas of the MWD or LWD tools.

As the drill bit 118 extends the wellbore 104 through the formations 106, the resistivity logging tool 126 may continuously or intermittently collect azimuthally-sensitive measurements relating to the resistivity of the formations 106 (i.e., how strongly the formations 106 opposes a flow of electric current). The resistivity logging tool 126 and other sensors of the MWD and LWD tools may be communicatively coupled to a telemetry module 128 used to transfer measurements and signals from the BHA to a surface receiver (not shown), to receive commands from the surface receiver, or both. The telemetry module 128 may be any type of downhole communication including, but not limited to, a mud pulse telemetry system, an acoustic telemetry system, an electromagnetic telemetry system, a wired communications system, a wireless communications system, or any combination thereof. In an example, some or all of the measurements taken at the resistivity logging tool 126 may be stored within the resistivity logging tool 126 or the telemetry module 128 for later retrieval at the surface 103 upon retracting the drill string 112.

At various times during a drilling process or upon completion of the drilling process, the drill string 112 may be removed from the wellbore 104, as shown in FIG. 2, to conduct measurement and logging operations using a wireline or a slickline deployed within the wellbore 104. For example, FIG. 2 is a cross-sectional view of an example wireline system 200. As illustrated, the wireline system 200 may include a wireline instrument sonde 202 that may be suspended in the wellbore 104 on a cable 204. The sonde 202 may include the resistivity logging tool 126 described above, which may be communicatively coupled to the cable 204. The cable 204 may include conductors for transporting power to the sonde 202 and also facilitate communication between the surface 103 and the sonde 202. A logging facility 206, shown in FIG. 2 as a truck, may collect measurements from the resistivity logging tool 126, and may include computing and data acquisition systems 208 for controlling, processing, storing, and/or visualizing the measurements gathered by the resistivity logging tool 126. The computing and data acquisition systems 208 may be communicatively coupled to the resistivity logging tool 126 by way of the cable 204.

While FIGS. 1 and 2 depict the systems 100 and 200 including vertical wellbores, principles of the present disclosure are equally well suited for use in wellbores having other orientations including horizontal wellbores, deviated wellbores, slanted wellbores or the like. Accordingly, any use of directional terms such as above, below, upper, lower, upward, downward, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well, the downhole direction being toward the toe of the well. Also, even though FIGS. 1 and 2 depict an onshore operation, it may be appreciated by those skilled in the art that principles of the present disclosure are equally well suited for use in offshore operations, wherein a volume of water may separate the drilling platform 102 and the wellbore 104.

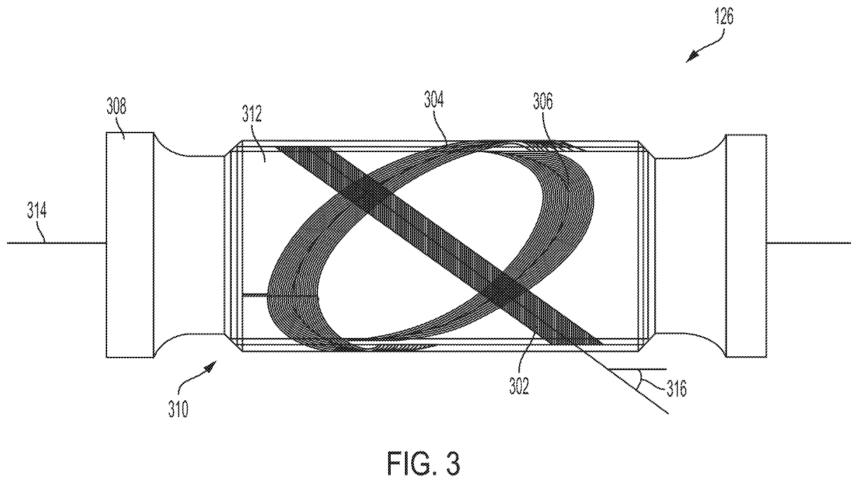

FIG. 3 is a side view of the resistivity logging tool 126 including three co-located loop antennas 302, 304, and 306. The resistivity logging tool 126 is depicted as including the three co-located loop antennas 302, 304, and 306 positioned about a tool mandrel 308, such as a drill collar. In an example, and as illustrated, the co-located loop antennas 302, 304, and 306 are wrapped about the tool mandrel 308, more particularly, within a saddle 310 of the tool mandrel 308. The saddle 310 may include a portion of the tool mandrel 308 that exhibits a reduced diameter as compared to other portions of the tool mandrel 308.

Each loop antenna 302, 304, and 306 may include any number of consecutive “turns” (i.e., windings of coil) about the tool mandrel 308. In general, the number of consecutive turns of the loop antennas 302, 304, and 306 may include at least two consecutive full turns, with each full turn extending 360 degrees about the tool mandrel 308. In some examples, a pathway for receiving each loop antenna 302, 304, and 306 may be formed in the saddle 310 and along an outer surface 312 of the tool mandrel 308. For example, one or more grooves or channels may be defined on the outer surface 312 of the tool mandrel 308 to receive and seat a respective loop antenna 302, 304, and 306. In other examples, and as illustrated, the outer surface 312 may be smooth or even. The loop antennas 302, 304, and 306 may be concentric or eccentric relative to a longitudinal axis 314 of the tool mandrel 308.

As illustrated, a portion of the turns or windings of each loop antenna 302, 304, and 306 may extend about the tool mandrel 308 at a winding angle 316 relative to the longitudinal axis 314. More specifically, the windings of the loop antennas 302, 304, and 306 extend about the outer surface 312 at the winding angles 316. The windings, however, transition to perpendicular to the longitudinal axis 314 at the top and bottom of the tool mandrel 308, at which point the windings transition back to the winding angle 316 on the sides of the tool mandrel 308. Successive windings of the loop antennas 302, 304, and 306 (i.e., one or more successive revolutions of coils of the antennas) advance in a generally axial direction along at least a portion of the outer surface of the tool mandrel 308 such that the loop antennas 302, 304, and 306 each spans an axial length of the tool mandrel 308.

In the illustrated embodiment, the winding angle 316 of all of the loop antennas 302, 304, and 306 is depicted as 54.7 degrees. While the winding angle 316 is 54.7 degrees for each of the loop antennas 302, 304, and 306, other winding angles are also contemplated. For example, the loop antennas 302, 304, and 306 may include a winding angle between 45 degrees and 65 degrees. Moreover, one or more examples may include different winding angles for each of the loop antennas 302, 304, and 306. Further, the loop antennas 302, 304, and 306 may be offset from each other by 120 degrees around a circumference of the saddle 310. In this manner, the loop antennas 302, 304, and 306 are distributed evenly around the surface 312 of the saddle 310.

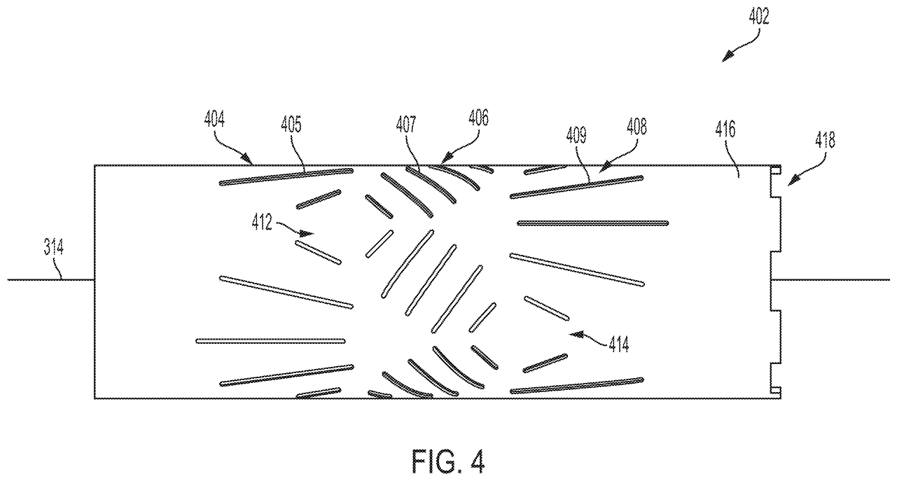

FIG. 4 is a side view of an antenna shield 402 (e.g., a triad antenna shield) for the resistivity logging tool 126. The antenna shield 402 may be positioned over the co-located loop antennas 302, 304, and 306 of the resistivity logging tool 126 to protect the co-located loop antennas 302, 304, and 306 from mechanical impacts. The antenna shield 402 may include a cross-slot shield design that defines a first set 404 of longitudinal slots 405, a second set 406 of longitudinal slots 407, and a third set 408 of longitudinal slots 409 to facilitate electromagnetic transmissivity of the antenna shield 402 by providing areas where electromagnetic (EM) signals can penetrate the antenna shield 402 to be received or transmitted by the loop antennas 302, 304, and 306. The antenna shield 402 may be referred to as a triad antenna shield because the antenna shield 402 is positioned on the resistivity logging tool 126 with the three co-located loop antennas 302, 304, and 306.

In the illustrated embodiment, each slot 405, 407, and 409 is formed in the shape of a rectangle, but could alternatively exhibit other shapes, without departing from the scope of the disclosure. Each slot 405, 407, and 409 is separated from an angularly adjacent slot 405, 407, and 409 by a separation gap. The separation gap may or may not be uniform between all angularly adjacent slots 405, 407, and 409. The slots 405 cooperatively form a first discontinuous annular ring that extends about the circumference of the antenna shield 402. Similarly, the slots 407 cooperatively form a second discontinuous annular ring that extends about the circumference of the antenna shield 402, and the slots 409 cooperatively form a third discontinuous annular ring that extends about the circumference of the antenna shield 402.

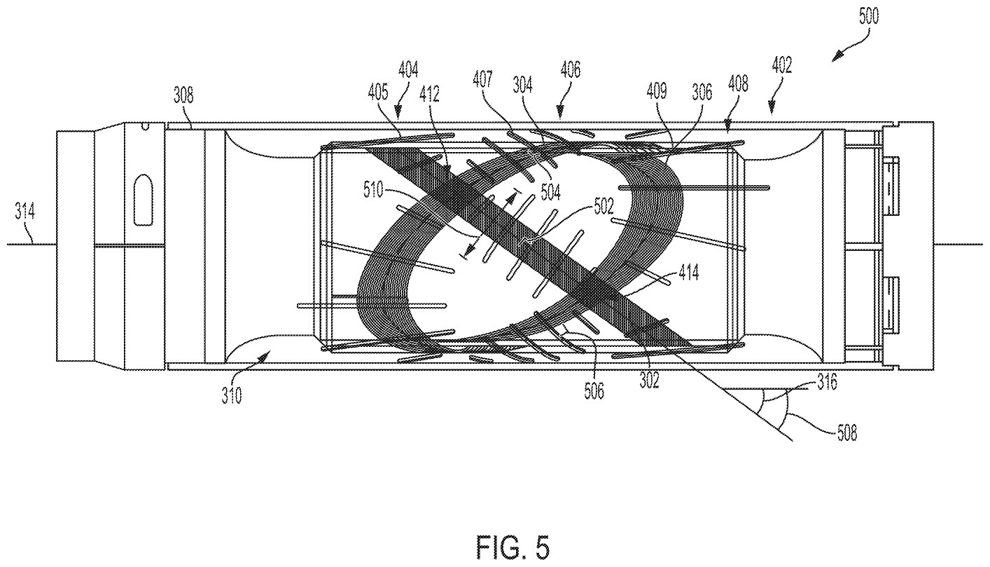

As illustrated, the length of the slots 405, 407, and 409 increase in a direction angularly away from points of intersection 412 and 414 of the loop antennas 302, 304, and 306 positioned within the antenna shield 402. Further, while only the points of intersection 412 and 414 are illustrated in FIG. 5, each loop antenna 302, 304, and 306 intersects with each of the other loop antennas 302, 304, and 306 twice. Accordingly, the antenna shield 402 may include 6 different points of intersection around a circumference of the antenna shield 402.

When installed on the resistivity logging tool 126, the antenna shield 402 may provide a circumferential encapsulation of the loop antennas 302, 304, and 306 by extending about the longitudinal axis 314. More specifically, the antenna shield 402 may be positioned radially outward from the loop antennas 302, 304, and 306 when installed on the resistivity logging tool 126. The antenna shield 402 can axially span an axial length of the saddle 310 and the antenna shield 402 may be secured to (or otherwise engaged with) the tool mandrel 308. In some embodiments, the antenna shield 402 may be designed such that a relatively smooth structural transition is achieved between the antenna shield 402 and the outer diameter of the tool mandrel 308 at the opposing axial ends of the antenna shield 402. Further, a toothed pattern 418 on one or both ends of the antenna shield 402 may interact with a complementary toothed pattern on the resistivity logging tool 126 to maintain the longitudinal slots 405, 407, and 409 of the antenna shield 402 in proper alignment with the loop antennas 302, 304, and 306.

In some embodiments, the antenna shield 402 can be formed of a non-conductive or non-metallic material, such as fiberglass or a polymer (e.g., polyether ether ketone or “PEEK”). In other embodiments, however, the antenna shield 402 can be made of a conductive or metallic material, such as stainless steel, a nickel-based alloy (e.g., MONEL®, INCONEL®, etc.), a chromium-based alloy, a copper-based alloy, or any combination thereof. Further, in an embodiment, the antenna shield 402 may include an outer-layer made of the conductive or metallic material and an inner-layer made from the non-conductive or non-metallic material. In an example, the non-conductive or non-metallic material may fill the slots 405, 407, and 409 such that a surface 416 of the antenna shield 402 is smooth along an entire length of the antenna shield 402. Additionally, the outer-layer and the inner-layer may each be approximately 0.125 inches thick.

FIG. 5 is a side view of the resistivity logging tool 126 with the antenna shield 402. The longitudinal slots 405 of the first set 404 may be arranged along and overlapping the radially adjacent loop antenna 302. The longitudinal slots 407 of the second set 406 may be arranged along and overlapping the radially adjacent loop antenna 304. Further, the longitudinal slots 409 of the third set 408 may be arranged along and overlapping the radially adjacent loop antenna 306. The longitudinal slots 405, 407, and 409 may be formed in the antenna shield 402 such that each longitudinal slot 405, 407, and 409 extends substantially perpendicular to the corresponding radially adjacent loop antenna 302, 304, and 306, as indicated by respective slot angles 502, 504, and 506, at any given angular location about the circumference of the tool mandrel 308. Stated otherwise, each slot extends perpendicular to the winding angle of the radially adjacent loop antenna. The perpendicular orientation of the longitudinal slots 405, 407, and 409 with respect to the loop antennas 302, 304, and 306 may reduce or minimize eddy currents induced within the antenna shield 402. Reducing the eddy currents induced within the antenna shield 402 may improve accuracy of the loop antennas 302, 304, and 306 when the antenna shield 402 is installed on the resistivity logging tool 126.

The centers of slots in each set 404, 406, and 408 trace the corresponding loop antenna 302, 304, and 306. In other words, the centers of the slots in each set 404, 406, and 408 may lie in a plane that is at an angle offset relative to the longitudinal axis 314. This angle may be referred to a “trace angle.” Trace angles 508 of the first set 404 of the longitudinal slots 405, the second set 406 of the longitudinal slots 407, and the third set 408 of the longitudinal slots 409 may be substantially similar to the winding angles 316 of the loop antennas 302, 304, and 306. For example, the winding angles 316 and the trace angles 422 may all be 54.7 degrees.

Due to the antenna shield 402, dipole EM fields of the loop antennas 302, 304, and 306, may be distorted. Such distortion of the dipole EM fields may result in effective EM field angles of the loop antennas 302, 304, and 306 being reduced as compared to effective EM field angles of the loop antennas 302, 304, and 306 operating without the antenna shield 402. For example, the effective EM field angle of the dipole EM field when the antenna shield 402 is installed around the loop antennas 302, 304, and 306 may be between 48 and 49 degrees depending on a frequency of the signals transmitted by the antennas 302, 304, and 306. For example, a lower frequency signal of 8 kHz may be closer to 48 degrees, while a higher frequency signal of 64 kHz may be closer to 49 or more degrees.

The distortion of the dipole EM fields, and the reduction of the effective EM field angle, may result from signal leakage from one or more of the loop antennas (e.g., the loop antenna 302) into one or more of the longitudinal slots (e.g., the longitudinal slots 407) associated with a different loop antenna (e.g., the loop antenna 304) to interfere with a signal radiating from the additional loop antenna actually associated with the one or more longitudinal slots. Because of the leakage of the EM fields between the longitudinal slots 405, 407, and 409, the effective EM field angles of each of the loop antennas 302, 304, and 306 may be changed.

To reduce or otherwise minimize leakage of the dipole EM fields of the co-located antennas 302, 304, and 306, the trace angles 508 of the first set 404 of the longitudinal slots 405, the second set 406 of the longitudinal slots 407, and the third set 408 of the longitudinal slots 409 may be varied such that a dipole EM field having a desired effective field angle is obtained. Additionally or alternatively, the slot angles 502, 504, and 506 of the longitudinal slots 405, 407, and 409 may be varied such that a dipole EM field having a desired effective field angle is obtained. In an example, the desired effective field angle may be within 3 degrees of the 54.7 degree winding angle 316 (e.g., between 51.7 and 57.7 degrees). In another example, an adequate effective field angle may be between 48 and 58 degrees regardless of the winding angle 316 of the loop antennas 302, 304, and 306.

Moreover, lengths 510 of the longitudinal slots 405, 407, and 409 may be adjusted to avoid leakage from EM fields between the longitudinal slots 405, 407, and 409. For example, the longitudinal slots 405, 407, and 409 that are the furthest from other loop antennas 302, 304, and 306 may be longer than the longitudinal slots 405, 407, and 409 that approach the points of intersection 412 and 414 between the loop antennas 302, 304, and 306. The relatively shorter lengths 510 of the longitudinal slots 405, 407, and 409 near the points of intersection 412 may increase structural integrity of the antenna shield 402 because less material is removed from the antenna shield 402 at the points of intersection. Further, the relatively shorter lengths 510 of the longitudinal slots 405, 407, and 409 limit the availability of the EM signals to leak into other longitudinal slots 405, 407, and 409.

The winding angles 316 of the loop antennas 302, 304, and 306 of the resistivity logging tool 300 are described herein as being 54.7 degrees. However, embodiments are not limited to the described winding angle 316. For example, the winding angles 316 of the loop antennas 302, 304, and 306 may include angles greater than 0° and less than 90° relative to the longitudinal axis 314. Further, the winding angles 316 of all of loop antennas 302, 304, and 306 may be the same or different.

In an example, to minimize the leakage of the dipole EM fields, the trace angles 508 (e.g., relative to the longitudinal axis 314) of the longitudinal slots 405, 407, and 409 may to decreased to less than 54.7 degrees. Additionally the slot angles 502, 504, and 506 of the longitudinal slots 405, 407, and 409 may be adjusted to a value less than 90 degrees to also minimize or otherwise reduce leakage of the dipole EM fields. Thus, the longitudinal slots 405, 407, and 409 may not always be perpendicular to the loop antennas 302, 304, and 306.

By adjusting the trace angles 508, the slot angles 502, 504, and 506, and the lengths 510 of the longitudinal slots 405, 407, and 409, the leakage of the dipole EM field may be reduced and a desired directionality of the dipole EM field may be obtained. An effective EM field angle of approximately 54.7 degrees may result from minimal cross-talk between the loop antennas 302, 304, and 306. It may be appreciated that under some values of the trace angles 508, the longitudinal slots 405, 407, and 409 may not overlap the corresponding loop antennas 302, 304, and 306. However, the EM field of the loop antennas 302, 304, and 306 may still diffract through the longitudinal slots 405, 407, and 409, and therefore the transmissivity characteristics of the antenna shield 402 may be maintained.

In other examples, the trace angles 508 may be maintained at 54.7 degrees, and the slot angles 502, 504, and 506 may be made less than 90 degrees relative to the loop antennas 302, 304, and 306. In such an example, the winding angles 316 of the loop antennas 302, 304, and 306 are be at about 54.7 degrees each. In still other examples, the slot angles 502, 504, and 506 may be at 90 degrees relative to paths of the radially adjacent loop antennas 302, 304, and 306, and the trace angles 508 may be increased to be greater than 54.7 degrees (e.g., 60 degrees). Further, in an example, the slot angles 502, 504, and 506 may be between 80 degrees and 90 degrees relative to the paths of the radially adjacent loop antennas 302, 304, and 306.

A shield gain of the magnetic field may also be taken into account when adjusting the trace angles 508, the slot angles 502, 504, and 506, the slot lengths 510, the winding angles 316, or a combination thereof. For example, the shield gain may be determined by dividing a magnetic field amplitude of resistivity logging tool 126 with the antenna shield 402 by a magnetic field amplitude of the resistivity logging tool 126 without the antenna shield 402. The trace angles 508, the slot angles 502, 504, and 506, the slot lengths 510, the winding angles 316, or a combination thereof may be adjusted to generate the shield gain that is greater than 0.25. That is, the antenna shield 402 may be optimized to maintain the shield gain at a level that reduces the magnetic field amplitude of the resistivity logging tool 126 without the antenna shield 402 by less than 75 percent.

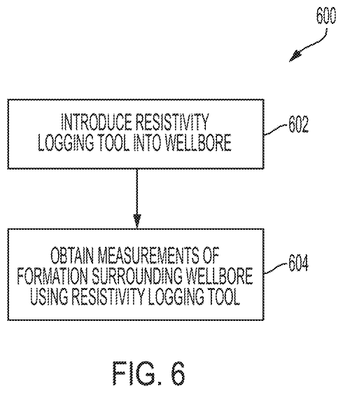

FIG. 6 is a flowchart of a process 600 for operating the resistivity logging tool 126. At block 602, the process 600 involves introducing the resistivity logging tool 126 with the antenna shield 402 into the wellbore 104. As discussed above with respect to FIGS. 1 and 2, the resistivity logging tool 126 may be introduced into the wellbore 104 during a drilling operation or during a wireline logging operation. Further, the resistivity logging tool 126 may be introduced into the wellbore 104 in both a land based well environment and a subsea well environment. Additionally, the resistivity logging tool 126 introduced into the wellbore 104 may include thee co-located loop antennas 302, 304, and 306, and the antenna shield 402 may include the first set 404 of the longitudinal slots 405, the second set 406 of the longitudinal slots 407, and the third set 408 of the longitudinal slots 409 where each set 404, 406, and 408 corresponds with an individual loop antenna 302, 304, and 306.

At block 604, the process 600 involves obtaining measurements of the formations 106 surrounding the wellbore 104 using the resistivity logging tool 126. In an example, the resistivity logging tool 126 may determine the electrical resistivity (or its inverse, conductivity) of the subterranean formations 106. The electrical resistivity or conductivity may indicate various geological features of the formations surrounding the wellbore 104. Because the shield gain is greater than 0.25 and the effective field angles are maintained within approximately 7 degrees of the winding angles 316 of the loop antennas 302, 304, and 306, the resistivity logging tool 126 with the antenna shield 402 is able to obtain useful formation measurements while protecting the loop antennas 302, 304, and 306 from damaging mechanical impacts within the wellbore 104.

In some aspects, systems, devices, and methods for providing a triad antenna shield for co-located antennas are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a triad antenna shield, comprising: a housing positionable radially external to loop antennas of a resistivity logging tool in a wellbore, the housing defining three slot sets each corresponding to a respective one of the loop antennas to overlap at least a portion of the respective loop antenna, with at least one slot of each slot set perpendicular to a trace angle with respect to a longitudinal axis, each slot set extending around a circumference of the triad antenna shield and through a first layer of the housing.

Example 2 is the triad antenna shield of example 1, wherein at least one of the slot sets comprises: a first slot comprising a first slot length; and a second slot comprising a second slot length that is different from the first slot length.

Example 3 is the triad antenna shield of example 1 or 2, wherein a first of the slot sets comprises a first orientation, a second of the slot sets comprises a second orientation, and a third of the slot sets comprises a third orientation, and wherein the second orientation is offset by 120 degrees around the circumference of the triad antenna shield from the first orientation and the third orientation is offset by 240 degrees around the circumference of the triad antenna shield from the first orientation.

Example 4 is the triad antenna shield of examples 1 to 3, wherein the housing comprises no more than the three slot sets to overlap no more than three antennas.

Example 5 is the triad antenna shield of examples 1 to 4, wherein the trace angle is between 48 degrees and 58 degrees.

Example 6 is the triad antenna shield of examples 1 to 5, further comprising a toothed pattern at an end of the triad antenna shield to mate with a complementary toothed pattern of the resistivity logging tool to maintain orientations of the three slot sets with respect to the resistivity logging tool.

Example 7 is the triad antenna shield of examples 1 to 6, wherein the three slot sets are positionable around the resistivity logging tool to generate a shield gain of greater than 0.25 during operation of the resistivity logging tool.

Example 8 is the triad antenna shield of examples 1 to 7, further comprising: the first layer comprising a metallic material and comprising the three slot sets; and a second layer comprising non-metallic material positionable within the first layer, wherein the second layer covers the three slot sets.

Example 9 is a wellbore logging tool, comprising: a loop antenna comprising a plurality of windings wrapped at a winding angle with respect to a longitudinal axis of the wellbore logging tool; a second loop antenna co-located with the loop antenna and comprising a second plurality of windings wrapped at a second winding angle with respect to the longitudinal axis; a third loop antenna co-located with the loop antenna and the second loop antenna and comprising a third plurality of windings wrapped at a third winding angle with respect to the longitudinal axis; and an antenna shield positionable radially external to the loop antenna, the second loop antenna, and the third loop antenna, wherein the antenna shield comprises a housing defining: a first set of slots extending through a section of the housing and positionable to overlap at least a portion of the loop antenna; a second set of slots extending through the section of the housing and positionable to overlap at least a portion of the second loop antenna; and a third set of slots extending through the section of the housing positionable to overlap at least a portion of the third loop antenna.

Example 10 is the wellbore logging tool of example 9, wherein the winding angle, the second winding angle, and the third winding angle are each between 45 and 65 degrees.

Example 11 is the wellbore logging tool of example 9 or 10, wherein the first set of slots comprises a first trace angle, the second set of slots comprises a second trace angle, and the third set of slots comprises a third trace angle, and wherein the first trace angle, the second trace angle, and the third trace angle are each between 45 and 65 degrees.

Example 12 is the wellbore logging tool of example 11, where the first trace angle, the second trace angle, and the third trace angle are different from the winding angle, the second winding angle, and the third winding angle.

Example 13 is the wellbore logging tool of examples 9 to 12, wherein each slot of the first set of slots is perpendicular to a path of the loop antenna, each slot of the second set of slots is perpendicular to a path of the second loop antenna, and each slot of the third set of slots is perpendicular to a path of the third loop antenna.

Example 14 is the wellbore logging tool of examples 9 to 13, wherein the first set of slots comprises a first slot angle with respect to a path of the loop antenna, the second set of slots comprises a second slot angle with respect to a path of the second loop antenna, and the third set of slots comprises a third slot angle with respect to a path of the second loop antenna, and wherein the first slot angle, the second slot angle, and the third slot angle are between 80 degrees and 90 degrees with respect to the paths of the loop antenna, the second loop antenna, and the third loop antenna.

Example 15 is the wellbore logging tool of examples 9 to 14, further comprising: a tool mandrel coupleable to a drill string or a wireline for insertion of the wellbore logging tool into a wellbore, wherein the loop antenna, the second loop antenna, the third loop antenna, and the antenna shield are positionable around the tool mandrel.

Example 16 is the wellbore logging tool of examples 9 to 15, wherein effective angles of electromagnetic signals transmitted from each of the loop antenna, the second loop antenna, and the third loop antenna through the antenna shield are within 7 degrees of the winding angle, the second winding angle, and the third winding angle.

Example 17 is the wellbore logging tool of examples 9 to 16, wherein a length of slots in the first set of slots increases in a direction angularly away from a point of intersection of the loop antenna and the second loop antenna or the third loop antenna.

Example 18 is a method, comprising: introducing a wellbore logging tool into a wellbore, the wellbore logging tool comprising: a loop antenna comprising a plurality of windings wrapped at a winding angle with respect to a longitudinal axis of the wellbore logging tool; a second loop antenna co-located with the loop antenna and comprising a second plurality of windings wrapped at a second winding angle with respect to the longitudinal axis; a third loop antenna co-located with the loop antenna and the second loop antenna and comprising a third plurality of windings wrapped at a third winding angle with respect to the longitudinal axis; and an antenna shield positionable radially outward from the loop antenna, the second loop antenna, and the third loop antenna, wherein the antenna shield comprises a housing defining: a first set of slots extending through a section of the housing and positionable to overlap at least a portion of the loop antenna; a second set of slots extending through the section of the housing and positionable to overlap at least a portion of the second loop antenna; and a third set of slots extending through the section of the housing and positionable to overlap at least a portion of the third loop antenna; and obtaining measurements of a surrounding subterranean formation with the wellbore logging tool.

Example 19 is the method of example 18, wherein introducing the wellbore logging tool into the wellbore further comprises: extending the wellbore logging tool into the wellbore on a drill string; and drilling a portion of the wellbore with a drill bit secured to the drill string.

Example 20 is the method of example 18, wherein introducing the wellbore logging tool into the wellbore further comprises: extending the wellbore logging tool into the wellbore on wireline as part of a wireline instrument sonde.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A triad antenna shield, comprising:
a housing positionable radially external to three loop antennas of a resistivity logging tool in a wellbore, the housing defining three slot sets each corresponding to a respective one of the loop antennas to overlap at least a portion of the respective loop antenna, with at least one slot of each slot set perpendicular to a trace angle with respect to a longitudinal axis, each slot set extending around a circumference of the triad antenna shield and through a first layer of the housing.

2. The triad antenna shield of claim 1, wherein at least one of the slot sets comprises:
a first slot comprising a first slot length; and
a second slot comprising a second slot length that is different from the first slot length.

3. The triad antenna shield of claim 1, wherein a first of the slot sets comprises a first orientation, a second of the slot sets comprises a second orientation, and a third of the slot sets comprises a third orientation, and wherein the second orientation is offset by 120 degrees around the circumference of the triad antenna shield from the first orientation and the third orientation is offset by 240 degrees around the circumference of the triad antenna shield from the first orientation.

4. The triad antenna shield of claim 1, wherein the housing comprises no more than the three slot sets to overlap no more than three antennas.

5. The triad antenna shield of claim 1, wherein the trace angle is between 48 degrees and 58 degrees.

6. The triad antenna shield of claim 1, further comprising a toothed pattern at an end of the triad antenna shield to mate with a complementary toothed pattern of the resistivity logging tool to maintain orientations of the slot sets with respect to the resistivity logging tool.

7. The triad antenna shield of claim 1, wherein the three slot sets are positionable around the resistivity logging tool to generate a shield gain of greater than 0.25 during operation of the resistivity logging tool.

8. The triad antenna shield of claim 1, further comprising:
the first layer comprising a metallic material and comprising the three slot sets; and
a second layer comprising non-metallic material positionable within the first layer, wherein the second layer covers the three slot sets.

9. A wellbore logging tool, comprising:
a loop antenna comprising a plurality of windings wrapped at a winding angle with respect to a longitudinal axis of the wellbore logging tool;
a second loop antenna co-located with the loop antenna and comprising a second plurality of windings wrapped at a second winding angle with respect to the longitudinal axis;
a third loop antenna co-located with the loop antenna and the second loop antenna and comprising a third plurality of windings wrapped at a third winding angle with respect to the longitudinal axis; and
an antenna shield positionable radially external to the loop antenna, the second loop antenna, and the third loop antenna, wherein the antenna shield comprises a housing defining:
a first set of slots extending through a section of the housing and positionable to overlap at least a portion of the loop antenna;
a second set of slots extending through the section of the housing and positionable to overlap at least a portion of the second loop antenna; and
a third set of slots extending through the section of the housing positionable to overlap at least a portion of the third loop antenna.

10. The wellbore logging tool of claim 9, wherein the winding angle, the second winding angle, and the third winding angle are each between 45 and 65 degrees.

11. The wellbore logging tool of claim 9, wherein the first set of slots comprises a first trace angle, the second set of slots comprises a second trace angle, and the third set of slots comprises a third trace angle, and wherein the first trace angle, the second trace angle, and the third trace angle are each between 45 and 65 degrees.

12. The wellbore logging tool of claim 11, wherein the first trace angle, the second trace angle, and the third trace angle are different from the winding angle, the second winding angle, and the third winding angle.

13. The wellbore logging tool of claim 9, wherein each slot of the first set of slots is perpendicular to a path of the loop antenna, each slot of the second set of slots is perpendicular to a path of the second loop antenna, and each slot of the third set of slots is perpendicular to a path of the third loop antenna.

14. The wellbore logging tool of claim 9, wherein the first set of slots comprises a first slot angle with respect to a path of the loop antenna, the second set of slots comprises a second slot angle with respect to a path of the second loop antenna, and the third set of slots comprises a third slot angle with respect to a path of the second loop antenna, and wherein the first slot angle, the second slot angle, and the third slot angle are between 80 degrees and 90 degrees with respect to the paths of the loop antenna, the second loop antenna, and the third loop antenna.

15. The wellbore logging tool of claim 9, further comprising:
a tool mandrel coupleable to a drill string or a wireline for insertion of the wellbore logging tool into a wellbore, wherein the loop antenna, the second loop antenna, the third loop antenna, and the antenna shield are positionable around the tool mandrel.

16. The wellbore logging tool of claim 9, wherein effective angles of electromagnetic signals transmitted from each of the loop antenna, the second loop antenna, and the third loop antenna through the antenna shield are within 7 degrees of the winding angle, the second winding angle, and the third winding angle.

17. The wellbore logging tool of claim 9, wherein a length of slots in the first set of slots increases in a direction angularly away from a point of intersection of the loop antenna and the second loop antenna or the third loop antenna.

18. A method, comprising:
introducing a wellbore logging tool into a wellbore, the wellbore logging tool comprising:
a loop antenna comprising a plurality of windings wrapped at a winding angle with respect to a longitudinal axis of the wellbore logging tool;
a second loop antenna co-located with the loop antenna and comprising a second plurality of windings wrapped at a second winding angle with respect to the longitudinal axis;
a third loop antenna co-located with the loop antenna and the second loop antenna and comprising a third plurality of windings wrapped at a third winding angle with respect to the longitudinal axis; and
an antenna shield positionable radially outward from the loop antenna, the second loop antenna, and the third loop antenna, wherein the antenna shield comprises a housing defining:
a first set of slots extending through a section of the housing and positionable to overlap at least a portion of the loop antenna;
a second set of slots extending through the section of the housing and positionable to overlap at least a portion of the second loop antenna; and
a third set of slots extending through the section of the housing and positionable to overlap at least a portion of the third loop antenna; and
obtaining measurements of a surrounding subterranean formation with the wellbore logging tool.

19. The method of claim 18, wherein introducing the wellbore logging tool into the wellbore further comprises:
extending the wellbore logging tool into the wellbore on a drill string; and
drilling a portion of the wellbore with a drill bit secured to the drill string.

20. The method of claim 18, wherein introducing the wellbore logging tool into the wellbore further comprises:
extending the wellbore logging tool into the wellbore on wireline as part of a wireline instrument sonde.
